(19) United States
(12) Patent Application Publication
(10) Pub. No.: US 2018/0126420 A1
(43) Pub. Date: May 10, 2018

(54) APPARATUS AND METHOD FOR SORTING ARTICLES

(71) Applicant: Compac Technologies Limited, Auckland (NZ)

(72) Inventors: Benjamin James Goodger, Auckland (NZ); Olga Perederieieva, Auckland (NZ); Nigel Jonathon Beach, Niigata (JP)

(21) Appl. No.: 15/572,124

(22) PCT Filed: May 6, 2016
(86) PCT No.: PCT/NZ16/50071

§ 371 Date: Nov. 6, 2017

(30) Foreign Application Priority Data
May 6, 2015 (NZ) 707823

(51) Int. Cl. B07C 5/04; B07C 5/16; B07C 5/342; G01G 15/00; B65B 25/04

(52) U.S. Cl. CPC B07C 5/04; B07C 5/16; B07C 5/342; G01G 2015/005; B65B 25/04; B07C 2501/0081; B07C 2501/009; G01G 15/001

(57) ABSTRACT

In one embodiment, an apparatus for sorting articles includes a carrier arranged to carry articles from an input to one of a plurality of outputs, a sorting controller arranged to control which output an article is delivered to dependent on a determined characteristic of the article and respective sorting criteria associated with each said output, wherein the sorting criteria comprise a value parameter of a completed package of articles associated with the respective outputs.

### TECHNICAL FIELD

The present invention, in embodiments thereof, generally relates to apparatus and methods for automatically sorting articles, particularly for articles such as fruit and vegetables.

### BACKGROUND ART

Processing lines for articles such as fruit often require different articles to be separated. This is an important commercial function, which may be used for example, to distinguish fruit destined for export and fruit destined for the local market. Manual grading of articles is costly, slow and prone to inaccuracies. Thus, automated methods and apparatus for grading articles have been developed. Known sorters can grade and sort produce by weight, colour, blemish, dimensions, shape, density, internal quality, etc.

Article carriers are used to transport articles such as fruit through various stages for grading purposes, and to eject fruit at a required location dependent on the result of the grading process. The use of one or more video cameras is one known method of automatically sensing characteristics of articles. The article carriers typically include an endless circuit of cups on a conveyor chain with the cup situated to unload fruit at one of a plurality of stations. Each cup is usually arranged to carry a single article in order to enable sensing of the individual articles.

The articles are typically weighed and videoed in order to detect blemishes, colour and generally grade each article to enable sorting of the articles into different outflows. These outlets or outflows lead to packaging stations where packages of graded articles are completed according to criteria such as a desired grade and package weight. Part of the sorting process directs articles to different outlets in order to enable completed packages at each packaging station to be as close as possible to the preferred criteria—for example that a completed package does not weight too much more than a required minimum weight. Weight (or count) of articles above a desired completed package weight (or count) are known as “give-aways” and represent “wasted” product that could have been used to complete another package and thereby reduces overall profit—the value of each completed package generally being fixed. An efficient sorting algorithm then needs to minimise giveaway and ensures that completed packages of fruit or other articles are as close to the minimum requirements as possible.

The reference to any prior art in the specification is not, and should not be taken as, an acknowledgement or any form of suggestion that the prior art forms part of the common general knowledge in any country.

### Object

It is an object of a preferred embodiment of the invention to provide an improved sorting apparatus and method which will overcome or ameliorate problems with such at present, or to at least provide the public with a useful choice.

Other objects of the present invention may become apparent from the following description, which is given by way of example only.

### SUMMARY

According to one aspect there is provided an apparatus for sorting articles and comprising a carrier arranged to carry articles from an input to one of a plurality of outputs, a sorting controller arranged to control which output an article is delivered to dependent at least in part on a determined characteristic of the article and respective sorting criteria associated with each said output, wherein the sorting criteria comprise a value parameter of a completed package of articles associated with the respective outputs.

By including value parameters associated with different types of completed packages of articles, the overall value of the packages completed by the sorting apparatus can be further improved compared with known sorting algorithms. The value may be a monetary value, for example a US dollar amount per package or per article. For example in an embodiment, a small bag of articles may have a higher dollar value per article than a large box of articles, and so a sorting algorithm which generates more high value small bags will generate more value even at the expense of less boxes and more giveaway in some completed packages.

The sorting criteria for each output may include one or more of the following: target weight of completed package; current weight of package; target article count of completed package; current article count of package; target article grade (e.g. colour or blemishes); monetary value of completed package. For example a completed small fruit tray at outlet 1 may have a target count of 4, target weight of 200 g, and value of $3 (or $0.75 per article); whereas a completed large fruit box at outlet 2 may have a target count of 40, target weight of 2 Kg, and value of $10 (or $0.40 per article). It can therefore be seen that allocating more articles to higher value packages, whilst still meeting other required sorting criteria, will result in more economic value for the same number of articles.

In an embodiment, the characteristic of the article includes its weight and/or a quality or grading parameter.

In an embodiment, the sorting controller is arranged to determine a suitability score for each article for each output, and to control the carrier to deliver the respective article to the outlet with the best suitability score. In an embodiment the best suitability score is the smallest, however this will depend on the algorithms, equations and calculations employed. The suitability score for each output may be dependent on a current weight of articles for a current uncompleted package.

In an embodiment, the apparatus further comprises a packaging station coupled to each output, each packaging station arranged to receive articles in order to complete packages of articles according to the respective sorting criteria.

In an embodiment, the apparatus further comprises a sensor for sensing articles to determine one or more said characteristics of each article, for example weight and/or colour or other grading characteristics.

The apparatus may comprise a plurality of parallel carriers for carrying articles to the outputs, in order to increase throughput.

In an embodiment the articles are fruit, although vegetables and other types of articles may alternatively be sorted. The completed packages may comprise two or more of the following: tray; small bag; large bag; box. The apparatus may comprise two or more outputs associated with the same value parameter, for example two outputs associated with a small bag.

According to another aspect there is provided a method of sorting articles and comprising: receiving a plurality of articles; allocating each article to one of a plurality of outputs dependent at least in part on a determined characteristic of the article and respective sorting criteria associated with each said output; wherein the predetermined criteria comprise a value parameter of a completed package of articles at the respective outputs.

In an embodiment, the method further comprises determining one or more characteristics of each of the plurality of articles.

In a further embodiment, the determining further comprises determining one or more allowable package type each article of the plurality of articles can be allocated to based on a minimum requirement for at least one of the one or more determined characteristics.

In another embodiment the determining comprises sensing each of the plurality of articles to determine a weight and/or a quality or a grading parameter.

In an embodiment, the value parameter of a complete package comprises a monetary value per complete package or per article.

In a further embodiment, the sorting criteria for each of the plurality of outputs comprise one or more of the following: a target weight of a complete package; a current weight of a package; a target article count of a complete package; a current article count of a package; a target article grade; an optimized weight range for a package; and a monetary value of a complete package.

In an embodiment, the allocating comprises determining a suitability score for each article for each of the plurality of outputs, and controlling a delivery of the respective article to the output with the best suitability score.

In a further embodiment, the method further comprises updating the sorting criteria of the output to which the last article was allocated.

In another embodiment, the allocating comprises determining one or more allowable package types an article can be allocated to based at least in part on an optimized weight range for a package; and controlling a delivery of the respective article to an output corresponding to one of the one or more allowable package types in a randomized manner. In an embodiment, the controlling comprises calculating a probability for each of the one or more allowable package types; and selecting one output corresponding to one of the one or more allowable package types by comparing a randomly generated probability to the calculated probabilities. The probabilities for each of the one or more allowable package types may further be dependent at least in part on the value parameter.

According to another aspect there is provided one or more non-transitory computer-readable medium that stores instructions that, when executed by a processor, cause the processor to: allocate each of a plurality of received articles to one of a plurality of outputs dependent at least in part on a determined characteristic of each of the plurality of received articles and respective sorting criteria associated with each of the plurality of outputs; wherein the predetermined criteria comprise a value parameter of a completed package of articles at the respective outputs.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Further aspects of the invention, which should be considered in all its novel aspects, will become apparent from the following description given by way of example of possible embodiments of the invention.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### BRIEF DESCRIPTION OF THE DRAWINGS

FIG. 1 shows a sorting apparatus according to an embodiment;

FIG. 2 shows a sorting algorithm according to an embodiment;

### DESCRIPTION OF EMBODIMENTS

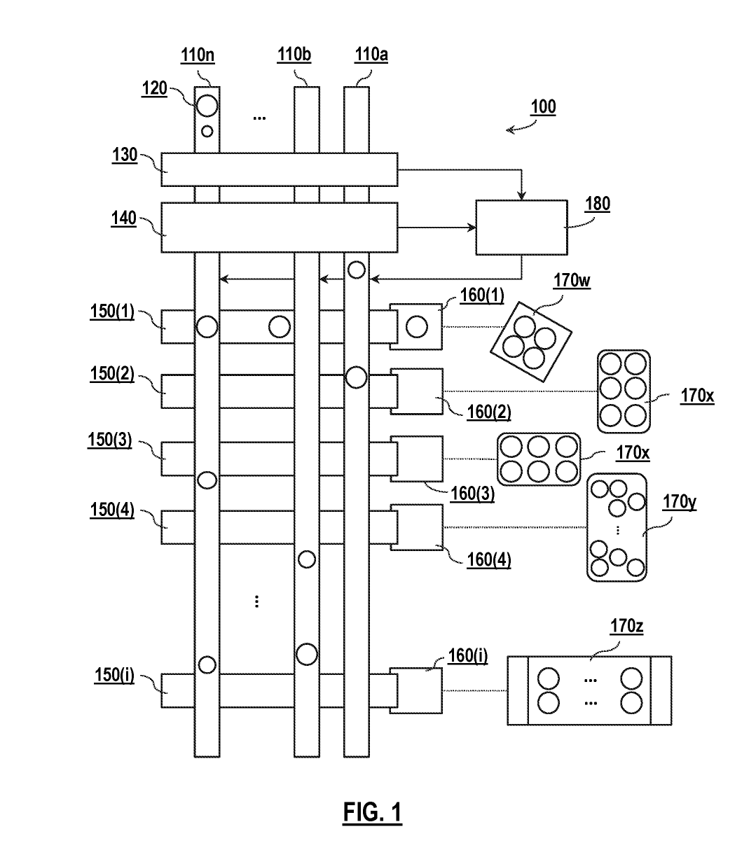

An apparatus for sorting articles according to an embodiment is shown in FIG. 1. The apparatus 100 comprises a plurality of parallel carriers 110a-110n for carrying articles 120 such as fruit or vegetables. Each carrier 110 receives articles singularly from a singulation process (not shown) and typically comprises an endless chain of cups, each cup for carrying a respective article. The cups allow the articles to be individually weighed and graded, as well as allowing the article to be ejected into one of a plurality of outputs 150(1)-150(i). Such carriers are commercially available for example from Compac Sorting Equipment Ltd, 11 Spring Street, Onehunga, Auckland 1643, New Zealand (http://www.compacsort.com) (Compac) and are described for example in US patent U.S. Pat. No. 7,410,044. Alternative carriers could be used, for example from different vendors and using different arrangements such as belts with or without single article pockets or partitions.

The outputs 150 or outlet channels may comprise water flumes to gently receive and transport the ejected articles to respective packaging stations 160(1)-160(i). Alternatively inclined trays or belts may be used. The packaging stations are arranged to package the articles into respective completed packages such as trays 170W, small bags 170X, large bags 170Y, and boxes 170Z as shown, although alternative packaging options will be readily apparent to those skilled in the art. Again such packaging stations will be well known to those in the art, and are commercially available for example from Compac.

The apparatus 100 also comprises a weigh bridge 130 which enables weighing of each article 120, as well as a grading sensor 140 which typically videos or photographs each article in order to determine colour and surface imperfections. Such weighing and grading arrangements are commercially available, for example from Compac. Additional or alternative sensing may be employed, of example dimensions (size and/or shape), density, internal properties using high intensity light or other non-intrusive means. These properties or determined characteristics for each article are provided to a sorting controller 180 which applies a sorting algorithm to control which output each article is delivered to. The sorting controller 180 may be any suitably configured processing device such as a computer, and typically includes at least one processor, a memory, a user interface and other components as is well known in the art. Again such sorting controllers are commercially available from Compac and other vendors. The operations of processor of the sorting controller may be implemented by instructions encoded in one or more tangible (non-transitory) memory media (e.g., embedded logic such as an application specific integrated circuit, digital signal processor instructions, software or program code that is executed by a processor, etc), wherein memory stores data used for operations described herein and stores software or processor executable instructions that are executed to carry out the operations described herein. The sorting algorithm implemented by the sorting controller 180 utilizes sorting criteria associated with each output 150—for example the current combined article weight or article count at the packaging station 160 associated with the output 150, together with a target or minimum weight or article count for a completed package. The current weight or count of a package may be determined using the controller's knowledge of articles already delivered to the packaging station, or using feedback signals from the packaging stations to the controller 180.

Thus for example, a newly weighed and graded article may be delivered to the first output 150(1) where it will complete a package 160(1) of articles at a combined weight only slightly higher than a minimum weight for that packaging station 150(1). In this way the giveaway is minimized compared with directing the article to another output at which the completed package would be significantly over the minimum weight, or where the combined weight would be just under the minimum weight and therefore require an additional article which is likely to take the combined weight well over the minimum required.

The embodiment also utilizes a value parameter of a completed package as part of the sorting criteria for the sorting algorithm. Example value parameters include monetary prices for the completed packages, for example a dollar value. For the packages shown in FIG. 1, the small tray 170W has a higher per article dollar value then the small bag 170X, which in turn has a higher dollar value per article than the large bag 170Y, with the box 170Z having the lowest dollar value per article. Therefore generating more trays 170W and small bags 170X will generate more revenue for a given number of articles.

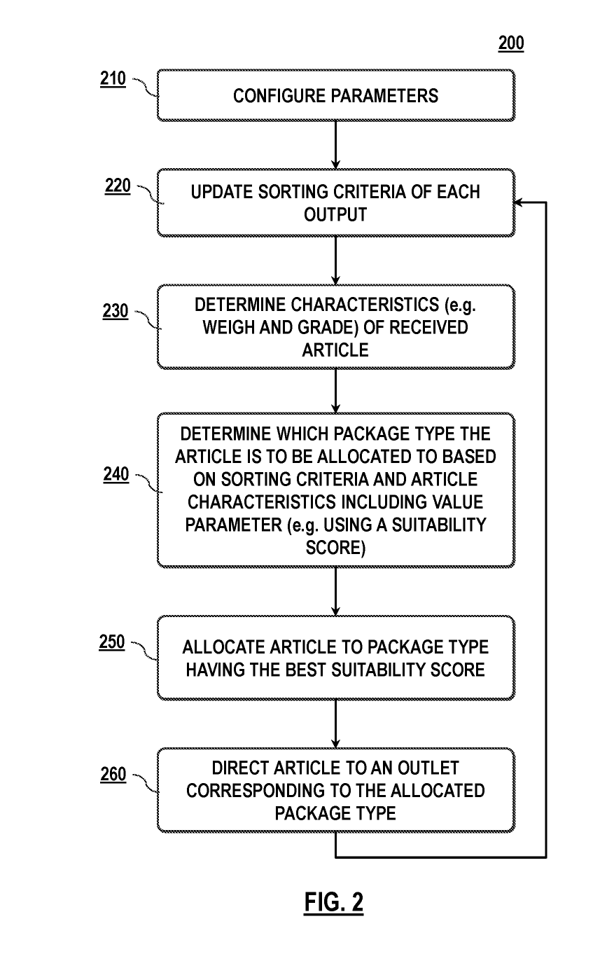

A sorting method or algorithm according to an embodiment is illustrated in FIG. 2. The method 200 can be implemented by any suitable controller 180, for example a computer, microcontroller or PDL. At a first step 210, the parameters of the method are configured, for example at a user interface of the controller 180. The parameters will include setting some of sorting criteria such as the minimum or target completed package weights for each outlet or packaging station, target articles counts for each completed package if used, article grade requirements (e.g. colour, percentage blemishes, etc.) for each outlet/packaging station/package, desired article throughput, desired number of completed packages (of each type).

At step 220, the method updates varying parameters such as current weights for each package, current article counts for each package, and so on. These parameters may be provided to the controller from the respective packaging stations, or may be determined from the controller knowledge of how many articles (and their combined weights) have already been delivered to each outlet and the known package requirements for each outlet. At step 230, the method determines one or more characteristics of a received article, for example weight using the weigh bridge 130 and/or colour using the grader 140.

At step 240, for each article, the method determines which package type the article is to be allocated to. The allowable package types may be limited by requiring a minimum grade of article for example, so that a low grade article may only be allocated to a small number of package types. Therefore a sub-step is to determine the allowable package types that the article may be allocated to.

The allowable package type that the article is ultimately allocated to is dependent on sorting criteria such as the grade and weight of the article, as well as a value parameter such as a dollar value of a completed package for each package type. In this embodiment, a suitability score is employed to incorporate the value parameter into the package type allocation decision, however other methods may alternatively be used.

A suitability score is determined for each allowable package type dependent on sorting criteria including a value parameter of a completed package. The package value may be a dollar value for example, and will vary depending on the package type. Different suitability scoring calculations may be performed in different situations, for example if adding the article would make the package overweight, underweight, or otherwise. Example suitability scoring calculations or algorithms are shown below:

Suitability Score of article for each allowable package type under consideration:

$$= \{ \begin{matrix}- {α}_{1} ( \frac{package value}{package count} ) + {β}_{1} {‖ \begin{matrix}target weight - \\ fruit weight\end{matrix} ‖}^{{γ}_{1}} \text{:} & Underweight \\ - {α}_{2} ( \frac{package value}{package count} ) + {β}_{2} {‖ \begin{matrix}target weight - \\ fruit weight\end{matrix} ‖}^{{γ}_{2}} \text{:} & Overweight \\ - {α}_{3} ( \frac{package value}{package count} ) + {β}_{3} {‖ \begin{matrix}target weight - \\ fruit weight\end{matrix} ‖}^{{γ}_{3}} \text{:} & Otherwise\end{matrix}$$

where:
Target weight=typically the minimum weight of a completed package for the outlet under consideration normalized by the package count.
Fruit weight=determined weight of the current article
Package value=dollar value of a completed package for the outlet under consideration
Package count=wanted/expected/minimum number of articles
α₁₋₃=the emphasis given to the value component for a given weight classification (under/over/other)
β₁₋₃=the emphasis given to the weight component for a given weight classification
γ₁₋₃=Additional scaling on the emphasis on the weight component (often close to 1)
   The above three coefficients can be determined experimentally, and then applied to a working apparatus. They may also be varied in real-time for example by an operator at the user interface of the controller 180, in order to optimize value or giveaway for example. A higher emphasis on the value component (greater αᵢ relative to βᵢ) leads to higher overall economic value but may increase “giveaway” to an amount unacceptable for the package type.

Actual values will be dependent on the units of both weight and value, however in an embodiment can be configured as follows:

$$\{ \begin{matrix}{α}_{1} much less than {β}_{1} , {γ}_{1} between 1 and 4 \text{:} & Underweight \\ {α}_{2} equivalent to {β}_{2} , {γ}_{1} between 1 and 4 \text{:} & Overweight \\ {α}_{3} much more than {β}_{3} , {γ}_{3} close to 1 \text{:} & Otherwise\end{matrix}$$

At step 250, once a suitability score is determined for each package type, the best (e.g. lowest) score is determined and the article allocated to the package type with the lowest score.

At step 260, the article is directed to the output corresponding to the package type, and the carrier 110 is controlled by the controller 180 to eject the article at that output. Some embodiments may include multiple outputs for one or more package types so that the embodiment needs to select between one or more outputs for the article. One of these outputs may not be allowable due to operational requirement such as a recent high flow rate requiring the packaging station to “catch-up” so as to avoid spillage of articles. Where there are two or more outputs associated with the same package type, these may be alternately allowed and disallowed in order to smooth and/or limit the flow of articles to each packaging station. Additional operational considerations related to allowing or disallowing particular outputs include: package in process of being sealed; minimize labor involved in closing package by controlling order of completion.

The method then returns to step 220, where the sorting criteria are updated, for example by updating the weight and count of the package to which the last article was allocated. Where the last package was completed, both the package weight (and count if used) will return to zero.

In another embodiment of the present invention, instead of using a suitability score, the articles are allocated to a particular allowable package type in a randomized fashion. A first sub-step includes defining and optimizing a weight range for each of the packages based on current statistical information about articles weights for each grade. This sub-step implements a statistical prediction model for estimating an average article weight for each package based on a mixture distribution and an algorithm for optimizing weight ranges that uses this model. During this first sub-step, an initial estimation of an average article weight for each grade may be provided either by retrieving data from the weigh bridge 130 and/or the grading sensor or from an external operator. Since package weight ranges might overlap, the statistical prediction model may be based on a mixture of distributions of overlapping weight ranges. The model estimates mean and variance of article weight in a given weight range with a given set of grades based on currently available estimate of an average article weight in the batch for each grade. Such an estimate is derived based on articles seen so far and also based on a truncated lognormal distribution for the weight ranges for which no articles has been seen yet.

After the range optimization sub-step, a given article is assigned to one of the allowable packages based on a randomized greedy choice. Typically, a randomized greedy algorithm is based on the idea of assigning different probabilities to available alternatives depending on how attractive each alternative is with respect to a given objective. In this embodiment, the probabilities may be calculated as the article value of each allowable package normalized by the total sum of the articles values for all the allowable packages. Once the probabilities are calculated, a random number may be generated and used to choose one of the allowable packages to which the article is to be allocated. For example, but not limited to, three allowable packages A, B, C with the following respective probabilities 0.5, 0.3 and 0.2 may be identified as suitable to receive a particular article. In a situation where the generated random number falls into the interval [0, 0.5], the article will be allocated to the allowable package A. On the other hand, if the generated random number falls into the interval [0.5, 0.8], the article will be allocated to the allowable package B. Otherwise, the article will be allocated to the last allowable package C.

During article allocation, the weight range optimization process changes the packages weight ranges so as to minimize weight “giveaway” and increase overall package value. This is achieved by shifting, enlarging and/or decreasing weight ranges in such a way that average article weight in a new optimized range is close to a desired value while taking into consideration that article with higher value will be assigned to a package with higher probability. The algorithm uses the proposed statistical prediction model to estimate mean fruit weight for new weight ranges and directs a search for a better weight ranges based on the output of the statistical model.

The method therefore effectively includes a value consideration into the sorting process. Known sorters work by minimising the “giveaway” that is to say the weight of fruit exceeding the minimum requirement per package. However, minimising weight “giveaway” alone does not usually result in the best economic outcome. The embodiments of the present invention described hereinabove sort articles based on package value while still meeting package weight requirements. This method improves the overall economic performance of the sorting apparatus, by maximising the value of packages generated for a given amount of incoming articles.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the invention.

What we claim is:

1. An apparatus for sorting articles, the apparatus comprising:
a carrier arranged to carry articles from an input to one of a plurality of outputs; and
a sorting controller arranged to control which of the plurality of outputs an article is delivered to dependent at least in part on a determined characteristic of the article and respective sorting criteria associated with each said plurality of outputs, wherein the sorting criteria comprise a value parameter of a completed package of articles associated with the respective outputs.

2. The apparatus of claim 1, wherein the value parameter of a complete package comprises a monetary value per complete package or per article.

3. The apparatus of claim 2, wherein a monetary value of a complete package at a first output is more than a monetary value of a complete package at a second output and the sorting controller is arranged to generate more complete packages at the first output even at the expense of less complete packages at the second output and more giveaway in the complete packages at the first output.

4. The apparatus of any one of the preceding claims, wherein the sorting criteria for each of the plurality of outputs comprise one or more of the following: a target weight of a complete package; a current weight of a package; a target article count of a complete package; a current article count of a package; a target article grade; and a monetary value of a complete package.

5. The apparatus of any one of the preceding claims, wherein the characteristic of the article comprises a weight and/or a quality or a grading parameter.

6. The apparatus of any one of the preceding claims, wherein the sorting controller is arranged to determine a suitability score for each article for each of the plurality of outputs, and to control the carrier to deliver the respective article to the output with the best suitability score.

7. The apparatus of claim 6, wherein the suitability score for each of the plurality of outputs is dependent on a current weight of articles for a current uncompleted package.

8. The apparatus of any one of the preceding claims, wherein the apparatus further comprises a packaging station coupled to each of said plurality of outputs, each packaging station being arranged to receive articles in order to complete packages of articles according to the respective sorting criteria.

9. The apparatus of any one of the preceding claims, wherein the apparatus further comprises a sensor for sensing articles to determine one or more said characteristics of each article.

10. The apparatus of any one of the preceding claims, wherein the apparatus further comprises one or more additional parallel carriers for carrying articles to the plurality of outputs, in order to increase throughput.

11. The apparatus of any one of the preceding claims, wherein the completed packages may comprise two or more of the following: a tray; a small bag; a large bag; and a box.

12. The apparatus of any one of the preceding claims, wherein two or more outputs of the plurality of outputs are associated with the same value parameter.

13. A method of sorting articles, the method comprising:
receiving a plurality of articles;
allocating each article of the plurality of articles to one of a plurality of outputs dependent at least in part on a determined characteristic of the article and respective sorting criteria associated with each of the plurality of outputs, wherein the sorting criteria comprise a value parameter of a completed package of articles associated with the respective outputs.

14. The method of claim 13, further comprising determining one or more characteristics of each of the plurality of articles.

15. The method of claim 14, wherein the determining further comprises determining one or more allowable package type each article of the plurality of articles can be allocated to based on a minimum requirement for at least one of the one or more determined characteristics.

16. The method of claim 14-15, wherein the determining comprises sensing each of the plurality of articles to determine a weight and/or a quality or a grading parameter.

17. The method of any one of claims 13-16, wherein the value parameter of a complete package comprises a monetary value per complete package or per article.

18. The method of any one of claims 13-17, wherein the sorting criteria for each of the plurality of outputs comprise one or more of the following: a target weight of a complete package; a current weight of a package; a target article count of a complete package; a current article count of a package; a target article grade; an optimized weight range for a package; and a monetary value of a complete package.

19. The method of any one of claims 13-18, wherein the allocating comprises determining a suitability score for each article for each of the plurality of outputs, and controlling a delivery of the respective article to the output with the best suitability score.

20. The method of any one of claims 13-19, further comprising updating the sorting criteria of the output to which the last article was allocated.

21. The method of any one of claims 13-18, wherein the allocating comprises determining one or more allowable package types an article can be allocated to based at least in part on an optimized weight range for a package; and controlling a delivery of the respective article to an output corresponding to one of the one or more allowable package types in a randomized manner.

22. The method of claim 21, wherein the controlling comprises calculating a probability for each of the one or more allowable package types; and selecting one output corresponding to one of the one or more allowable package types by comparing a randomly generated probability to the calculated probabilities.

23. The method of claim 22, wherein the probabilities of the one or more allowable package types are dependent at least in part on the value parameter.

24. One or more non-transitory computer-readable medium that stores instructions that, when executed by a processor, cause the processor to:
allocate each of a plurality of received articles to one of a plurality of outputs dependent at least in part on a determined characteristic of each of the plurality of received articles and respective sorting criteria associated with each of the plurality of outputs; wherein the predetermined criteria comprise a value parameter of a completed package of articles at the respective outputs.
